(19) United States
(12) Patent Application Publication
(10) Pub. No.: US 2009/0063169 A1
(43) Pub. Date: Mar. 5, 2009

(54) Extending Industry Certifications to an Uncertified Party

(75) Inventor: David Carr Holloway, Baldwinsville, NY (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 11/846,759

(22) Filed: Aug. 29, 2007

(51) Int. Cl. G06Q 99/00

(52) U.S. Cl. 705/1

(57) ABSTRACT

A certified party can assist an uncertified party to gain access to a business requiring certification. The uncertified party requests that certification be extended by the certified party over a product made by the uncertified party. The certified party, certifying body and/or notified body evaluates the quality systems, procedures and production facilities of the uncertified party to determine if they satisfy the certification requirements. Many components of the product requiring certification are provided by the certified party to the uncertified party. Optionally, uncertified components for the product may be provided by the certified party or a third party. The uncertified party uses the components to manufacture the product. Product documentation is provided to the notified body. The notified body evaluates the documentation and conducts an investigation into the product. Upon receipt of certification, the uncertified party may mark the product with a certification mark.

### BACKGROUND

The current invention is directed to the certification of products or processes in certain industries, and more particularly to a method of providing business opportunities in areas or for products requiring certification to an uncertified party through the use of another party's certification.

Product certification is the process of certifying that a certain product has passed performance and/or quality assurance tests or qualification requirements stipulated in regulations such as a building code and nationally accredited test standards or that it complies with a set of regulations governing quality and/or minimum performance requirements.

Certification of products may indicate their established suitability for a specified purpose (e.g. a computer system might be certified as being fully compatible with a large software package). In addition, product certification enables the imposition of standards for safety related articles and systems. Once certified, products may be endorsed with a quality mark or be eligible to display a certification mark.

To begin the certification process, a certifying body or notified body typically audits those who may seek certification of products or processes. The party seeking certification typically submits its quality system procedures to the certifying organization. The audit of the quality system includes all information necessary to make the product, including descriptions of the equipment, how to run it, purchasing specifications for components and quality control measures for the components as they arrive in the factory or assembly area. With the process standard in its possession, the certifying body typically inspects the manufacturing process of the product that is intended to be certified. In addition, in order to receive certification for the product, the site making or assembling the product may need to be certified in order to verify that proper procedures and quality control parameters are in place at the point of assembly. Furthermore, the certifying body may require that employees of the entity seeking certification undergo specific and periodic training related to the certification. In one exemplary embodiment, the initial audit of the party seeking certification is completed by the notified body, while subsequent audits can be completed by the notified body and/or a certified party.

Unfortunately, the large amount of cost, time, and resources needed to obtain certification may discourage all but the largest companies from obtaining certification in many instances. Some companies may not have the money, capabilities, or resources to be able to afford to invest in the possibility of obtaining certification. Furthermore, some companies may only make a few products that could take advantage of the certification and, standing alone, the income from those products may not be worth the investment in the certification. Furthermore, because the opportunity to obtain certification in a particular industry is effectively limited to a select few members, innovation can also be limited in the industry covered by the certification.

What is needed in the art is a method and system for extending the certification of a certified party to a third party that wants to produce a product that will receive that certification. What is further needed in the art is a method for providing a party that produces a product with certification of that product without the producing party having to go through the certification process.

### BRIEF DESCRIPTION OF THE DRAWINGS

For a more complete understanding of the exemplary embodiments of the present invention and the advantages thereof, reference is now made to the following description in conjunction with the accompanying drawings in which:

FIG. 1 is a flowchart illustrating the general steps of a process for extending industry certifications to a third party in accordance with an exemplary embodiment of the present invention.

FIG. 2 is a flowchart illustrating a process for a certified party receiving a request for the extension of the certified party's certification over a product made by a producing party in accordance with an exemplary embodiment of the present invention.

FIG. 3 is a flowchart illustrating a process for auditing the producing party to determine if it is capable of assembling a certified product under the certification requirements in accordance with an exemplary embodiment of the present invention.

FIG. 4 is a flowchart illustrating a process for providing certified components to the producing party to assemble a product in accordance with an exemplary embodiment of the present invention.

FIG. 5 is a flowchart illustrating a process for certifying a product in accordance with an exemplary embodiment of the present invention.

FIG. 6 is a flowchart illustrating a process for a business to market a product with an industry certification without the business actually being certified in accordance with an exemplary embodiment of the present invention.

Like reference symbols in the various drawings indicate like elements.

### DETAILED DESCRIPTION OF THE EXEMPLARY EMBODIMENTS

The present invention supports a method and system for extending the certification of a certified party over a producing party that is not certified. Exemplary embodiments of the invention can be more readily understood by reference to the accompanying figures. While the exemplary embodiment will be described in reference to extending Atmospheres Explosive (“ATEX”) certification to a producing party, it should be recognized that the inventive methods described herein should not be limited to ATEX certification, but can be used to extend certification, standards, or qualification rights (hereinafter generally referred to as “certification”) of other certification, standards, or qualification bodies to a non-certified producing party with only minor adjustments known to those of ordinary skill in the art based on each standards or certifying body's particular requirements.

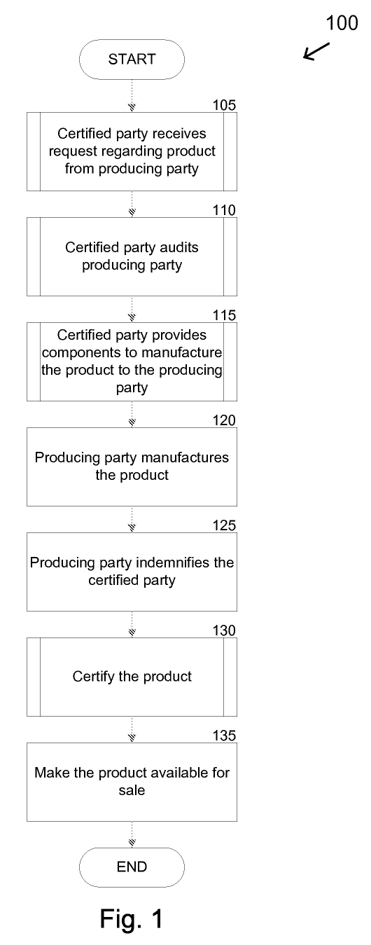

Referring now to the drawings, in which like numerals represent like elements throughout the several figures, aspects of the present invention and an exemplary operating environment for the implementation of the present invention will be described. FIGS. 1-6 are logical flowchart diagrams illustrating exemplary methods for extending the certification of a certified party to a third party that is not certified (hereinafter an “uncertified party” or “producing party”) but wants to produce a product or practice a process (hereinafter referred to generally as a “product”) that will receive that certification.

FIG. 1 is a logical flowchart diagram 100 presented to illustrate the general steps of an exemplary process for extending industry certifications of a certified party to an uncertified party in accordance with an exemplary embodiment of the present invention. Now referring to FIG. 1, the exemplary method 100 begins at the START step and proceeds to step 105, in which a certified party receives a request regarding the assembly or manufacture of a product from a producing party. In one exemplary embodiment, the certified party has already received certification from a certified body or standards board. The certification may be related to a particular facility or product line for the certified party. Furthermore, in one exemplary embodiment, the producing party is not certified or has not received certification for the product that it wants to manufacture; however those of skill in the art will recognize that the producing party may hold other certifications and/or may be certified by the relevant certified body but not for operations at the particular facility or for the particular product line for which certification is sought. In an alternative embodiment, the certified party may not yet be certified but may be in or about to begin the process of obtaining the certification that it will extend to the producing party.

In one exemplary embodiment, the certification being sought by the producing party is ATEX certification. ATEX certification is applicable to electrical equipment and systems manufacturing. Compliance with the ATEX certification facilitates the free movement of goods throughout the European Union by harmonizing the technical and legal requirements for products intended for use in potentially explosive gas or dust atmospheres. The products covered by ATEX certification include any equipment which contains or constitutes a potential ignition source and which requires special measures to be incorporated to prevent initiating an explosion. The certification also covers safety and control devices installed outside of a hazardous area but having an explosion protection function. The certification further covers protective systems and items that prevent an explosion that has been initiated from spreading or causing damage.

In step 110, the certified party or notified body, such as Underwriters Laboratories for example, audits the producing party to determine if its products, processes, manufacturing or assembly area and quality control procedures satisfy the standards of the ATEX certification. The certified party or other available certified parties provide components for creating the product to the producing party in step 115. In one exemplary embodiment, the components provided by the certified party are components that satisfy the ATEX certification or are suitable for use with the ATEX certified product. In one exemplary embodiment, only the components that must meet the ATEX certification requirement are supplied by the certified party or another available certified party to the producing party. In this exemplary embodiment, the certified party manufactures or procures the certified components prior to supplying them to the producing party.

In step 120, the producing party assembles or manufactures the product. In one exemplary embodiment, at least a portion of the components for the product must be ATEX certified. The producing party indemnifies the certified party in step 125. In one exemplary embodiment, the indemnification covers any loss by the certified party related to the product or having the product certified. However, those of ordinary skill in the art will recognize that greater or less amounts of indemnification can be provided by the producing party. In step 130, the certified party has the product certified under the certification procedures. In one exemplary embodiment, under the ATEX certification procedures, the certified party would provide the product to a notified body that would conduct the certification. In certain exemplary embodiments, a notified body is a testing laboratory and certification organization. Typically each national government notifies (or designates) one or more testing/certification labs as an agency able to issue certifications. The product is made available for sale in step 135. In one exemplary embodiment, the product is made available for sale by the producing party. The process then continues from step 135 to the END step.

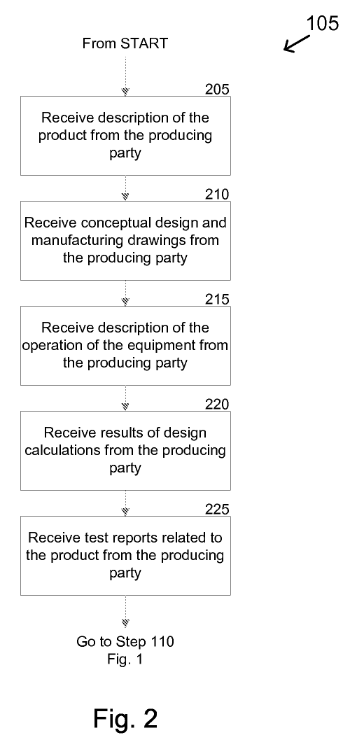

FIG. 2 is a logical flowchart diagram illustrating an exemplary method for a certified party receiving a request for the extension of the certified party's certification over a product made by a producing party as contemplated by step 105 of FIG. 1. Referencing FIGS. 1 and 2, the exemplary method 105 begins with the certified party receiving a description of the product from the producing party in step 205. In step 210, the certified party receives conceptual design, manufacturing, and/or assembly drawings from the producing party related to the product for which certification is requested.

In step 215, the certified party receives a description of the operation of the product, for which certification is requested from the producing party. The producing party may or may not provide to the certified party results of design calculations for the product in step 220. In step 225, the certified party may or may not receive test reports from the producing party related to the product for which certification is requested. In certain exemplary embodiments, the certified party has test reports for a product that is similar to the product to be offered by the producing party and the certified party is able to use those test reports in place of testing reports for the producing party's product. The process then proceeds from step 225 to step 110 of FIG. 1.

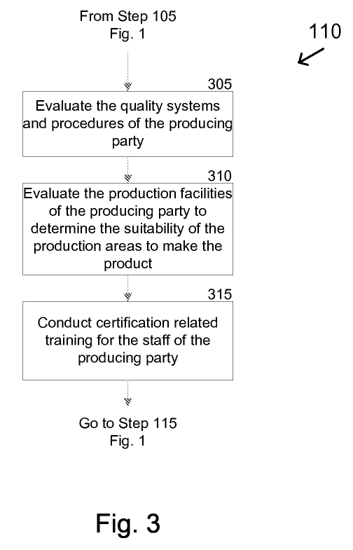

FIG. 3 is a logical flowchart diagram illustrating an exemplary method for auditing the producing party to determine if the producing party is capable of assembling a certified product under the certification requirements as contemplated by step 110 of FIG. 1. In one exemplary embodiment, the auditing steps are completed by the certified party; however those of ordinary skill in the art will recognize that a third party including, but not limited to, another certified party, the notified body, or the certifying body could complete the audit of the producing party. Now referring to FIGS. 1 and 3, the exemplary method 110 begins with the evaluation of the quality systems and procedures of the producing party in step 305. In one exemplary embodiment, the evaluation is limited to systems and procedures impacting the product for which certification is being sought.

In step 310, an evaluation and audit of the production area or facilities of the producing party is completed to determine the suitability of the production area to make the product for which certification is sought. In one exemplary embodiment, the audit is limited to the production facility or portion thereof that the product will be made or assembled. Certification related to the training of the staff for the producing party on matters related to ATEX certification is conducted in step 315. In one exemplary embodiment, the certification step includes training a portion of the staff of the producing party on all or a portion of the issues necessary to maintain ATEX certification status under the certified body.

In one exemplary embodiment, the audit of the producing party will be conducted on a periodic basis to ensure that the quality systems, procedures and facility remain up to the standards required by the certified party. In one exemplary embodiment, the standards required by the certified party equate to the standards of the certifying body. In one exemplary embodiment, the audits are updated or conducted on an annual basis.

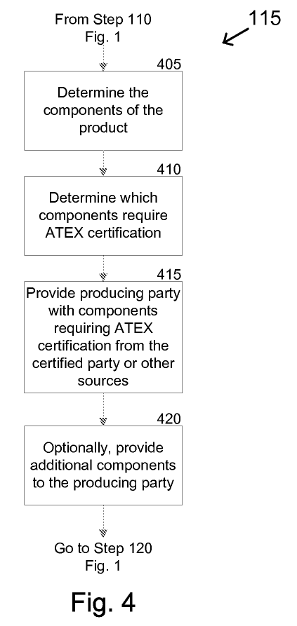

FIG. 4 is a logical flowchart diagram illustrating an exemplary method for providing certified components to the producing party to manufacture or assemble the product for which ATEX certification is sought as contemplated by step 115 of FIG. 1. Referencing FIGS. 1 and 4, the exemplary method 115 begins in step 405 with a determination of the components that will be needed to manufacture or assemble the product. In one exemplary embodiment the determination of components is made by the certified party; however the producing party or a third party could make this determination. In step 410, a determination is made as to which components require ATEX certification. As with step 405, the determination of step 410 can be made by the certified party, producing party or a third party.

The certified party or another party that is certified provides the producing party with the components that require ATEX certification in step 415. In one exemplary embodiment, the components provided by the certified party were made or assembled by the certified party. In step 420, additional components for the product, for which certification is requested, may optionally be provided to the producing party. These components may be provided by the certified party or another party that may or may not be certified. In one exemplary embodiment, the additional components do not require ATEX certification. In one exemplary embodiment, the additional components are provided by a third party. In one exemplary embodiment, the product for which certification is requested only requires components having ATEX certification and thus, no additional components are provided to the producing party. The process continues from step 420 to step 120 of FIG. 1.

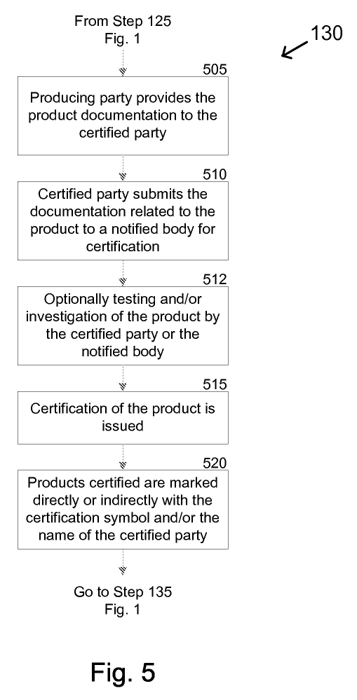

FIG. 5 is a logical flowchart diagram illustrating an exemplary method for certifying the product made or assembled by the producing party under the certified party's ATEX certification as contemplated by step 130 of FIG. 1. Referencing FIGS. 1 and 5, the exemplary method 130 begins at step 505 with the producing party providing the product and/or product documentation to the certified party for ATEX certification. In one exemplary embodiment, the product documentation may include, but is not limited to, product descriptions, test reports, product drawings, instruction sheets and quality reports. In step 510, the certified party submits the product documentation related to the product made or assembled by the producing party to a third party capable of completing the ATEX certification. In one exemplary embodiment, the third party is a notified body or a certifying body, such as, for example, Underwriters Laboratories, Inc. In step 512, the notified body conducts an investigation into and may optionally test the product as part of the certification process.

In step 515, an ATEX certification for the product is issued by the notified body. In one exemplary embodiment, the certification is issued in the name of the certified party. In this exemplary embodiment, the certification remains with the certified party even if the producing party attempts to discontinue relations with the certified party. For example, if the producing party attempted to buy ATEX certified components from a third party and not make use of the certified party, the third party would not be able to provide the certification acquired by the certified party for the product. In step 520, the certified products are marked. In one exemplary embodiment, marking of the certified products includes placing the certification symbol on the certified product. In another exemplary embodiment, marking of the certified product includes placing the name of the certified party on the certified product. In another exemplary embodiment, for products, certifications or standards that do not require direct marking, indirect marking methods may be used for the product including, but not limited to placement of the certification or standards symbol and/or name of the certified party on the packaging or instructions of the product. The process continues from step 520 to step 135 of FIG. 1.

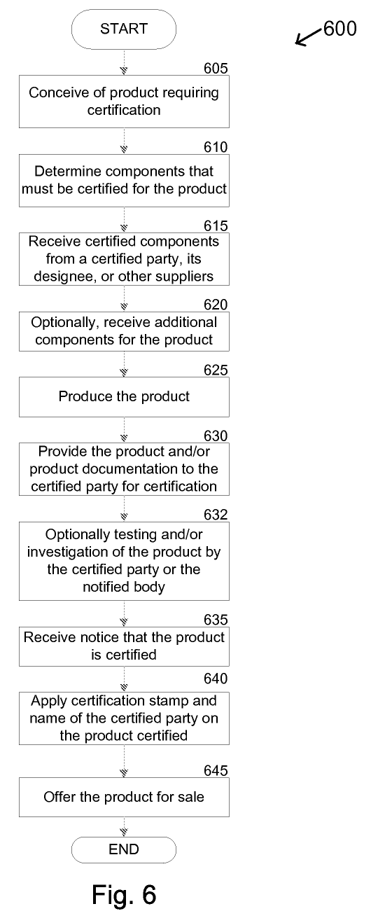

FIG. 6 is a logical flowchart diagram 600 presented to illustrate the general steps of an exemplary process for a producing party to market a product with an industry certification without the producing party being certified in accordance with an exemplary embodiment of the present invention. Now referring to FIG. 6, the exemplary method 600 begins at the START step and proceeds to step 605, in which the producing party conceives of a product requiring certification or that must satisfy a particular standards body. In step 610, a determination is made as to which components for the product need to be certified. In one exemplary embodiment, the determination is made by the certified party, the producing party, another party or any combination thereof. In one exemplary embodiment, another party can include, but is not limited to, an engineer, consultant or another supplier of certified products.

In step 615, the producing party accepts the certified components for the product from the certified party, a designee of the certified party, or other suppliers. The producing party may accept additional components that do not require certification for the product in step 620 if and as necessary. In one exemplary embodiment, the additional components may be received from the certified party, another certified party, a third party or may be created or acquired by the producing party. In step 625, the producing party makes and/or assembles the product for which certification is desired.

The producing party presents the product and/or product documentation for certification in step 630. In one exemplary embodiment, the product and/or product documentation is provided to the certified party by the producing party. In certain exemplary embodiments, the product documentation includes, but is not limited to, product descriptions, test reports, drawings, instruction sheets and quality reports. The certified party submits the product and/or product documentation to the certifying body or notified body qualified to certify the product. In step 632, the notified body conducts an investigation into and may optionally test the product as part of the certification process. After the product is certified by the notified body, certifying body or standards body, as the case may be, the producing party receives notice of the same in step 635.

In an alternative embodiment, the certified party can extend a preexisting certification for another product to cover the product being manufactured by the producing party. This option of extending the certification is generally available if the product made by the producing party and the product already certified are substantially similar to one another or if the product being manufactured by the producing party is a subset of the certified product. In this alternative embodiment, there would be no need for the certified party to submit the product or documentation to the notified body or to receive another certification from the notified body. In step 640, the certification stamp, or mark, and in some instances the name of the certified party, is applied to the product that was certified. In step 645, the producing party offers the certified product for sale. The process continues from step 645 to the END step.

In conclusion, the foregoing exemplary embodiments enable a certified party to extend its certification to a non-certified party. Many other modifications, features, and embodiments will become evident to a person of ordinary skill in the art having the benefit of the present disclosure. It should be appreciated, therefore, that many aspects of the invention were described above by way of example only and are not intended as required or essential elements of the invention unless explicitly stated otherwise. Accordingly, it should be understood that the foregoing relates only to certain embodiments and that numerous changes can be made therein without departing from the spirit and scope of the invention, as defined by the following claims. It should also be understood that the invention is not restricted to the illustrated embodiments and that various modifications can be made within the scope of the following claims.

What is claimed is:

1. A method of assisting a producing party to gain access to a business requiring certification comprising the step of:
accepting a request to extend certification to a product manufactured by the producing party, wherein the product comprises at least one certified component;
providing at least a portion of the certified components to the producing party, wherein the producing party manufactures the product;
interacting with the certifying party to achieve certification of the product; and
notifying the producing party that the product has been certified.

2. The method of claim 1, wherein the product further comprises a plurality of uncertified components; and
wherein the method further comprises the step of providing at least some of the uncertified components to the producing party.

3. The method of claim 1, further comprising the step of requiring indemnification from the producing party with respect to potential losses related to the product.

4. The method of claim 1, further comprising the step of receiving from the producing party technical documentation relating to the product.

5. The method of claim 1, further comprising the step of auditing one or more of a quality system, a quality control procedure and a production area of the producing party.

6. The method of claim 1, wherein the certification comprises ATEX certification.

7. A method for obtaining certification of a product offered by a producing party, wherein the product comprises at least one certified component, the method comprising the steps of:
soliciting a certified party to present the product to a certifying party for certification;
receiving the certified components from the certified party;
producing the product using at least the certified components;
providing the product to the certified party, wherein the certified party interacts with the certifying party to achieve certification of the product; and
receiving notice that the product has been certified.

8. The method of claim 7, wherein the product further comprises a plurality of uncertified components; and
wherein the method further comprises the step of receiving at least some of the uncertified components from the certified party.

9. The method of claim 7, wherein the product further comprises a plurality of uncertified components; and
wherein the method further comprises the step of receiving at least some of the uncertified components from a third party.

10. The method of claim 7, further comprising the step of marking the product with a certification mark.

11. The method of claim 7, wherein the certification mark comprises the name of the certified party.

12. A method of a certified party assisting a producing party to obtain ATEX certification of a product, wherein the product comprises at least one ATEX certified component, the method comprising the steps of:
accepting a request to extend ATEX certification to the product offered by the producing party;
receiving technical documentation relating to the product from the producing party;
conducting an audit of the producing party, wherein the audit comprises an evaluation of one or more of a quality system, quality control procedure, manufacturing procedure and production area of the producing party;
providing at least a portion of the ATEX certified components to the producing party, wherein the producing party manufactures the product using at least the ATEX certified components;
submitting a certification request to a certifying party in order to request ATEX certification for the product, wherein the certification request includes at least a portion of the technical information;
receiving extension of the ATEX certification for the product from the certifying party; and
permitting the producing party to mark the product with an ATEX certification mark prior to making the product available for sale.

13. The method of claim 12, further comprising the step of requiring indemnification from the producing party with respect to losses related to the product.

14. The method of claim 12, further comprising the step of providing at least a portion of the remaining components for the product to the producing party, wherein the remaining components do not require certification.

15. The method of claim 14, wherein another portion of the remaining components is provided to the producing party by a third party.

16. The method of claim 12, wherein the certification for the product is in the name of the certified party.

17. A method of a certified party assisting a producing party to obtain ATEX certification of a product, wherein the product comprises at least one ATEX certified component, the method comprising the steps of:
accepting a request to extend ATEX certification to the product offered by the producing party;
receiving technical documentation relating to the product from the producing party;
conducting an audit of the producing party, wherein the audit comprises an evaluation of one or more of a quality system, quality control procedure, manufacturing procedure and production area of the producing party;
providing the ATEX certified components to the producing party, wherein the producing party manufactured the product using at least the ATEX certified components;
extending an existing ATEX certification to cover the product, wherein the product is a subset of a certified product offered by a certified party; and
permitting the producing party to mark the product with an ATEX certification mark.

18. The method of claim 17, further comprising the step of providing at least a portion of the remaining components for the product to the producing party, wherein the remaining components do not require certification.

19. The method of claim 18, wherein another portion of the remaining components is provided to the producing party by a third party.

20. The method of claim 17, wherein the certification for the product is in the name of the certified party.

21. The method of claim 17, further comprising the steps of:
conceiving of a product line comprising a product for which certification is available;
determining a plurality of components that make up the product in the product line; and
determining if a portion of the components that make up the product require certification.
